(19) United States
(12) Patent Application Publication
(10) Pub. No.: US 2011/0310635 A1
(43) Pub. Date: Dec. 22, 2011

(54) LIGHT GUIDE ASSEMBLY FOR PORTABLE ELECTRONIC DEVICE

(75) Inventor: MING-CHUN HSIUNG, Shindian (TW)

(73) Assignee: FIH (HONG KONG) LIMITED, Kowloon (HK)

(21) Appl. No.: 12/981,509

(22) Filed: Dec. 30, 2010

(30) Foreign Application Priority Data
Jun. 18, 2010 (CN) 201020229383.7

(51) Int. Cl. F21V 8/00

(52) U.S. Cl. 362/615

(57) ABSTRACT

A light guide assembly includes a light source and a light guide plate. A through hole is defined in the light guide plate to receive the light source. A plurality of spaced apart apertures is defined in the light guide plate to allow the light rays to from the light source to be transmitted to illuminate the distal end of the light guide plate.

### BACKGROUND

1. Technical Field

The present invention relates to a light guide assembly for illuminating keys of a keyboard or keypad utilized in a portable electronic device.

2. Description of Related Art

Portable electronic devices, such as mobile phones, personal digital assistants (PDAs), and game players, are widely used in our daily life. Portable electronic devices usually include keyboards or keypads so information may be input to the portable electronic device. The keypads need to be illuminated so that the buttons on the keypads can be identified in the dark. Each button of conventional portable electronic devices may be illuminated by a respective light source located directly beneath the button. This arrangement is, however, expensive since a separate light source is required for each button. Additionally, the light sources consume a lot of power, which causes great inconvenience.

Therefore, there is room for improvement within the art.

### BRIEF DESCRIPTION OF THE DRAWINGS

Many aspects of the exemplary embodiment of a light guide assembly for a portable electronic device can be better understood with reference to the following drawings. The components in the drawings are not necessarily drawn to scale, the emphasis instead being placed upon clearly illustrating the principles of the portable electronic device. Moreover, in the drawings, like reference numerals designate corresponding parts throughout the several views, in which:

FIG. 1 is an isometric view of a light guide plate for a portable electronic device.

FIG. 2 is a top plan of the light guide assembly of FIG. 1.

FIG. 3 is similar to FIG. 2, but showing a light path of a light ray.

### DETAILED DESCRIPTION

The disclosure is illustrated by way of example and not by way of limitation in the accompanying drawings. It should be noted that references to “an” or “one” embodiment in this disclosure are not necessarily to the same embodiment, and such references can include the meaning of “at least one” embodiment where the context permits.

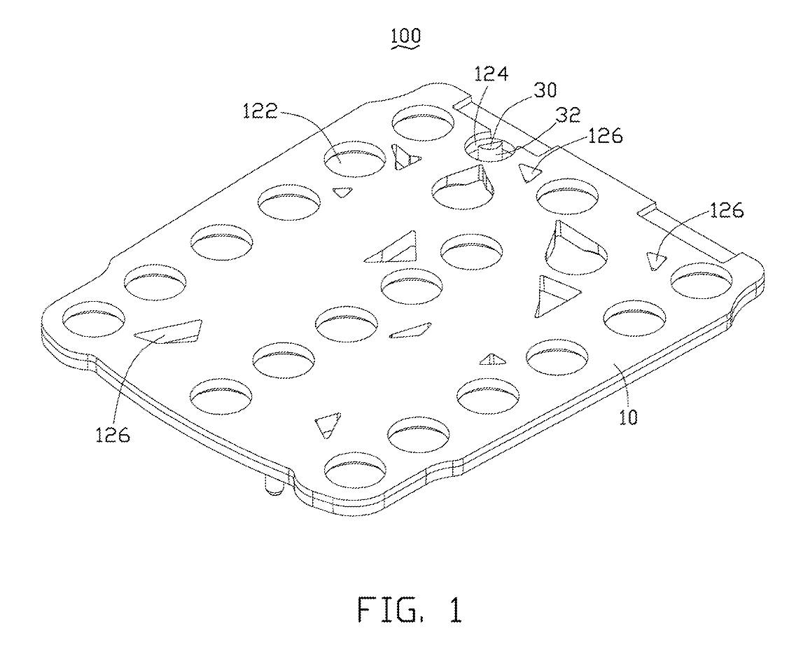

FIG. 1 illustrates a light guide assembly 100 for illuminating a keypad of a portable electronic device where a keypad is desired. The light guide assembly 100 includes a light guide plate 10 and a light source 30 to illuminate the light guide plate 10. A through hole 124 is defined at one end of the light guide plate 10. A light source 30 is received in through hole 124. A number of apertures 126 are spaced apart and defined in the light guide plate 10 so that the light rays from the light source 30 can be transmitted to illuminate the other end of the light guide plate 10.

The light guide plate 10 is transparent and has a substantially rectangular outline in accordance with the exemplary embodiment. A material of the light guide plate 10, which is suitably formed by injection molding, may be any suitable optical quality transparent material such as polymethyl methacrylate (PMMA), or polycarbonate (PC). An array of receiving holes 122 are defined in the light guide plate 10 to receive buttons (not shown). When the buttons are located within the receiving holes 12, the light from the light source 30 can be directed into the buttons. In this exemplary embodiment, the receiving holes 122 are substantially arranged in six rows and three columns.

Each aperture 126 is surrounded by a peripheral wall. The peripheral wall includes transmitting surfaces and reflecting surfaces. The transmitting surfaces transmit light to the receiving holes 122, thereby illuminating the buttons. The reflecting surfaces transmit light to the next receiving holes 122. During design of the light guide plate 10, a computer simulates the light rays from the light source 30. The positions and shapes of the reflecting surfaces of each aperture 126 are configured to pass the light to a distant position.

In practice, a method of designing a light guide includes the following steps: a position of each receiving hole 122 is determined as desired. An initial computer simulation for the light guide is performed to determine which positions are strong or weak for the light. A reflecting surface of each aperture is designed by aiming a ray trace at the weak position. During this step, the angle of a reflecting surface of each aperture 126 is adjusted to be greater than the critical total internal reflection so the light of the weak receiving holes 122 is improved.

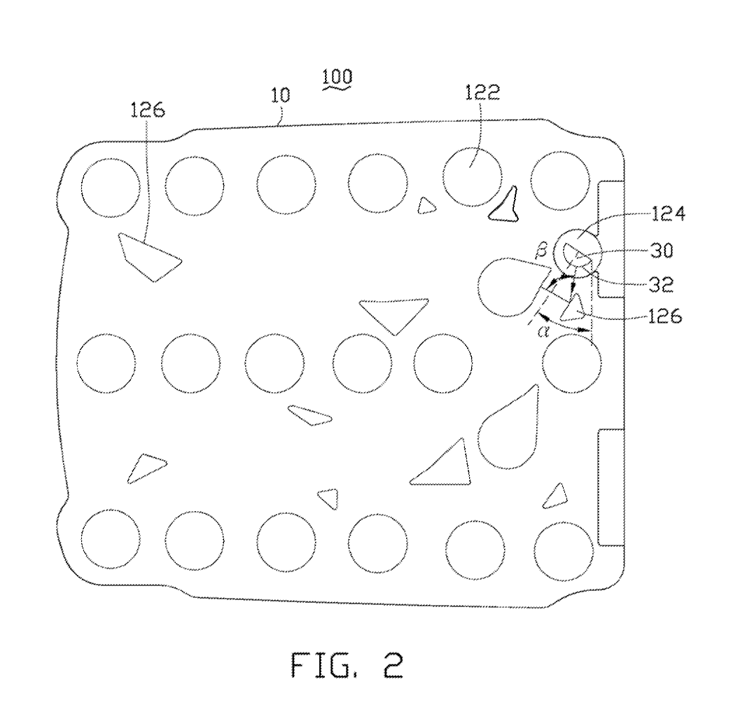

Referring to FIG. 2, in the exemplary embodiment, the light source 30 is semi-cylindrical. An angle between the symmetric line of the light source 30 and the horizontal line parallel to the adjacent side of the light guide plate 10 is defined as “α”. In the exemplary embodiment, the α is about 48-53 degrees, the a is such defined to ensure the light rays from the light source 30 to illuminate the distal end of the light guide plate 10.

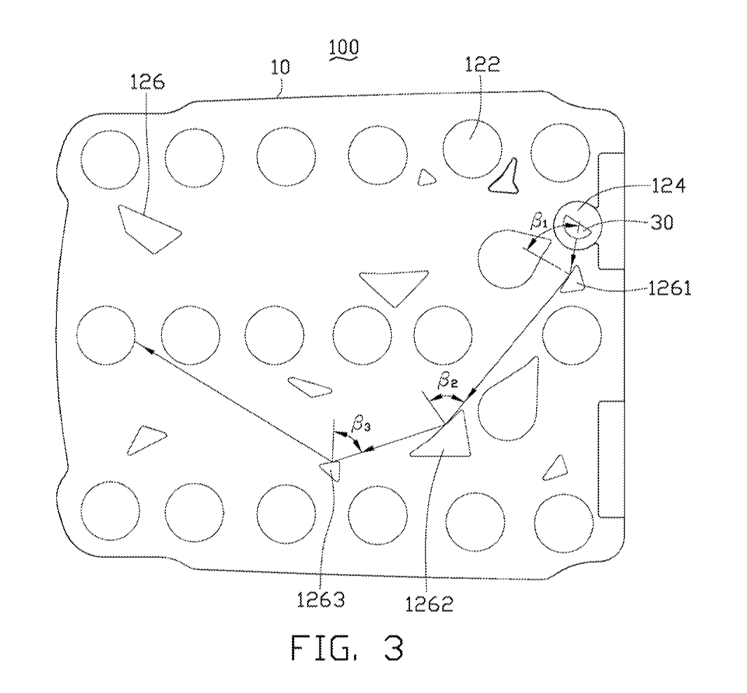

Referring to FIG. 3, one light ray is shown to explain how to configure a position of reflecting surfaces of the apertures 126. An angle of incidence light ray with respect to the normal line of the reflecting surface of the aperture 126 is defined as “β”. The β is greater than the critical angle of the material of the light guide plate 10.

When the light ray strikes the reflecting surface of a first aperture 1261 with an incidence angle of β₁, the light ray is reflected to a distant position, such as to a second aperture 1262, as shown in FIG. 3. The light ray is reflected by the reflecting surface of the second aperture 1262 with an incidence angle of β₂ and strikes the reflecting surface of a third aperture 1263. Similarly, the light ray is reflected by the reflecting surface of the third aperture 1263 with an incidence angle of β₃. The values of β₁, β₂, and β₃ decrease with an increase in distance from light source to allow the path of the light ray to change and to enter into the receiving hole 122 in the distal end.

As described above, the preferred embodiments provide a light guide yielding a desired uniform light by means of a single light source, thus requiring little power.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light guide assembly comprising:
a light source; and
a light guide plate, a through hole defined at one end of the light guide plate for received the light source, a plurality of apertures that are spaced apart and defined in the light guide plate to allow light rays from the light source to be transmitted to another end of the light guide plate.

2. The light guide assembly as claimed of claim 1, wherein the light source is semi-cylindrical.

3. The light guide assembly as claimed of claim 1, wherein an angle between a symmetric line of the light source and a line along the adjacent side of the light guide plate is about 48 to about 53 degrees.

4. The light guide assembly as claimed of claim 1, wherein each aperture is surrounded by a peripheral wall, the peripheral wall including reflecting surfaces, positions and shapes of the reflecting surfaces transmit light from the light source to a distant position from the light source.

5. The light guide assembly as claimed of claim 4, wherein an angle of each reflecting surface is greater than the critical angle of the material of the light guide plate.

6. The light guide assembly as claimed of claim 5, wherein the angles of the reflecting surfaces of the plurality of apertures decreases with an increase in distance from the light source.

7. The light guide assembly as claimed of claim 1, wherein the light guide plate is made of polymethyl methacrylate or polycarbonate.

8. A light guide assembly comprising:
a light source; and
a light guide plate, a through hole defined in the light guide plate to received the light source, a plurality of receiving holes that are spaced apart and defined in the light guide plate, a plurality of apertures defined in the light guide plate to allow light rays from the light source to be transmitted to illuminate the plurality of receiving holes.

9. The light guide assembly as claimed of claim 8, wherein the light source is semi-cylindrical.

10. The light guide assembly as claimed of claim 8, wherein an angle between a symmetric line of the light source and a line along the adjacent side of the light guide plate is about 48 to about 53 degrees.

11. The light guide assembly as claimed of claim 8, wherein each aperture is surrounded by a peripheral wall including reflecting surfaces, positions and shapes of the reflecting surfaces transmit light from the light source to a distant position from the light source.

12. The light guide assembly as claimed of claim 11, wherein an angle of each reflecting surface is greater than the critical angle of the material of the light guide plate.

13. The light guide assembly as claimed of claim 12, wherein the angles of the reflecting surfaces of the plurality of apertures decreases when the aperture is defined next to a distal end of the light guide plate.

14. The light guide assembly as claimed of claim 8, wherein the light guide plate is made of polymethyl methacrylate or polycarbonate.
